(19) United States
(12) Patent Application Publication
(10) Pub. No.: US 2025/0378111 A1
(43) Pub. Date: Dec. 11, 2025

(54) NATURAL AUDIO UNDERSTANDING FOR MONITORING SECURITY RECORDINGS

(71) Applicant: Coram AI, Inc., Sunnyvale, CA (US)

(72) Inventors: Peter Ondruska, London (GB); Ashesh Jain, Sunnyvale, CA (US)

(21) Appl. No.: 19/025,642

(22) Filed: Jan. 16, 2025

Related U.S. Application Data
(63) Continuation of application No. 18/739,144, filed on Jun. 10, 2024, now abandoned.

(51) Int. Cl. G06F 16/438; G10L 25/54; G10L 25/57

(52) U.S. Cl. CPC G06F 16/438; G10L 25/54; G10L 25/57

(57) ABSTRACT

Embodiments are disclosed for using natural audio understanding for monitoring security recordings. A method includes obtaining, using a text query model, a query embedding corresponding to a text query. One or more audio embeddings are identified that match the query embedding. Matching audio data corresponding to the one or more matching audio embeddings is obtained from a surveillance recording data store. The matching audio data is returned in response to receipt of the text query.

### BACKGROUND

Video surveillance has become ubiquitous in modern life. It is now common for users to set up and manage home video surveillance systems, with multiple competing device ecosystems to choose from. In the business or enterprise context, video surveillance is generally provided by cameras in and around an office, job site, etc. These cameras may feed real-time video data to a central security desk and/or record the footage for later review.

### SUMMARY

Embodiments are disclosed for using natural audio understanding for monitoring security recordings. A method includes obtaining, using a text query model, a query embedding corresponding to a text query. One or more audio embeddings are identified that match the query embedding. Matching audio data corresponding to the one or more matching audio embeddings is obtained from a surveillance recording data store. The matching audio data is returned in response to receipt of the text query.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of searching recording data in accordance with one or more embodiments;

FIG. 2 illustrates a diagram of a process of indexing surveillance data for search in accordance with one or more embodiments;

FIG. 3 illustrates a diagram of a process of providing analytics data corresponding to recording events in accordance with one or more embodiments;

FIG. 4 illustrates a diagram of an alarm system in accordance with one or more embodiments;

FIG. 5 illustrates a diagram of a process of generating alarms based on real-time recording monitoring in accordance with one or more embodiments;

FIG. 6 illustrates a diagram of a question answering system for surveillance recordings in accordance with one or more embodiments;

FIG. 7 illustrates a flowchart of a series of acts in a method of searching surveillance recording data in accordance with one or more embodiments; and

FIG. 8 illustrates a block diagram of an exemplary computing device in accordance with one or more embodiments.

FIG. 9 illustrates a block diagram of an exemplary system in accordance with one or more embodiments.

### DETAILED DESCRIPTION

One or more embodiments of the present disclosure apply audio understanding techniques to surveillance data recordings. Audio understanding is a feature that allows users to leverage microphones installed at a customer site (e.g., as part of existing close circuit television (CCTV) cameras, standalone microphones, etc.) to perform event identification and event search, such as the occurrence of certain keywords (e.g., “delivery”), topics (e.g., “people having an argument”), particular sounds (e.g., “gunshot”, “dog barking”, “glass breaking,” etc.

Traditional surveillance systems collect a lot of raw data. This is particularly true for businesses which may use a large number of cameras to monitor their offices, warehouses, campuses, etc. While such monitoring may provide some deterrence effects, actually using the surveillance data can be quite difficult. For example, identifying a relevant object or person of interest by manually reviewing hours of recordings across tens or hundreds of devices is expensive, time consuming, and resource intensive. In addition to the raw video data being collected, typically these cameras, along with potentially other audio recording devices, also collect a lot of raw audio data. Making use of the raw audio data to identify relevant events is likewise a difficult task, which typically also requires significant resources to sift through the raw data.

Recently, multi-modal machine learning techniques have enabled natural language processing (NLP) to be used with image and video systems. For example, multi-modal models, such as Contrastive Language-Image Pretraining (CLIP), allow for a mix of data from different domains (e.g., text data and image/video data) to be applied to a specific task. However, existing approaches do not function well when applied to the business surveillance domain. For example, such systems are not typically trained on video surveillance data. This results in inaccurate or incomplete results being returned in response to NLP queries. Additionally, existing machine learning-enabled systems typically rely on AI enhanced camera devices. These cameras may include additional onboard processing to perform object detection, facial recognition, etc. However, such devices are expensive and typically lock a user in to a specific provider. Further, such devices are not regularly replaced, leading to outdated technology being left to handle increasingly complex real world surveillance issues. Additionally, existing systems do not typically apply audio understanding to surveillance data, instead relying on the video contents of the surveillance data to identify potential events.

Embodiments address these and other deficiencies in the prior art using an audio/video search system that is implemented on-site at the customer's surveillance location (office, campus, warehouse, etc.). The system includes one or more cameras, a local network, and a Network Video Recorder (NVR) which performs various audio/video processing tasks. In some embodiments, the NVR may process solely audio data. Alternatively, the NVR may process a combination of audio and video data. The NVR can generate audio embeddings for audio data that is recorded at the customer's surveillance location. In some embodiments, audio embeddings may be generated for various time windows of the recording (e.g., each half second, second, two second, etc.). This allows for different sized snippets of the audio to be represented by embeddings. The embedding(s) can be stored in an audio index and the audio is stored in recording storage. In some embodiments, the recording data may also include corresponding video data, transcripts, etc. All of this is maintained locally on the NVR or on a dedicated device connected to the same local network. The NVR is compatible with any image/video capture device. Accordingly, the NVR provides an intelligent layer operating on top of the video surveillance system. This allows for existing infrastructure to be used.

In some embodiments, the audio/video search system includes a query system. The query system can be implemented separately and integrated into the NVR and/or via a separate client device. The query system allows for arbitrary text queries to be received and used to search for matching content in the audio data. The query system is powered by a text query network which receives the text query and outputs an embedding (e.g., a query vector). The query vector is matched to similar audio vectors in the audio index to identify portions of the audio that match the query. This greatly simplifies the review and search of existing surveillance data. Rather than requiring one or more users to sift through raw data in hopes of finding a particular event (e.g., specific person speaking, particular sound of interest, etc.) the audio/video search system can identify likely matching audio snippets based on natural language queries provided by a user.

In addition to returning the specific audio/video data corresponding to an identified event, in some embodiments the audio/video search system may also provide event analytics. For example, the audio/video search system may include an analytics system. The analytics system can identify events associated with the query and return event statistics instead of or in addition to, the raw audio/video data corresponding to the event.

Additionally, in some embodiments, the audio/video search system may include an alarm system. Alarms may be defined based on a natural language description of the alarm conditions, or a specific sound associated with the alarm. This allows for real-time monitoring of the video surveillance data by the audio/video search system. When an alarm condition is detected, one or more actions can be performed, such as notifying one or more persons associated with the alarm, activating other on-site systems, calling emergency services, etc.

Further, in some embodiments, a question answering system may be included in the audio/video search system. The question answering system can process recorded and/or live audio to answer a question received from a user or other entity. For example, audio snippets may be retrieved that are relevant or otherwise related to the question. These audio snippets may then be processed to determine an answer to the question and then the answer is returned to the user.

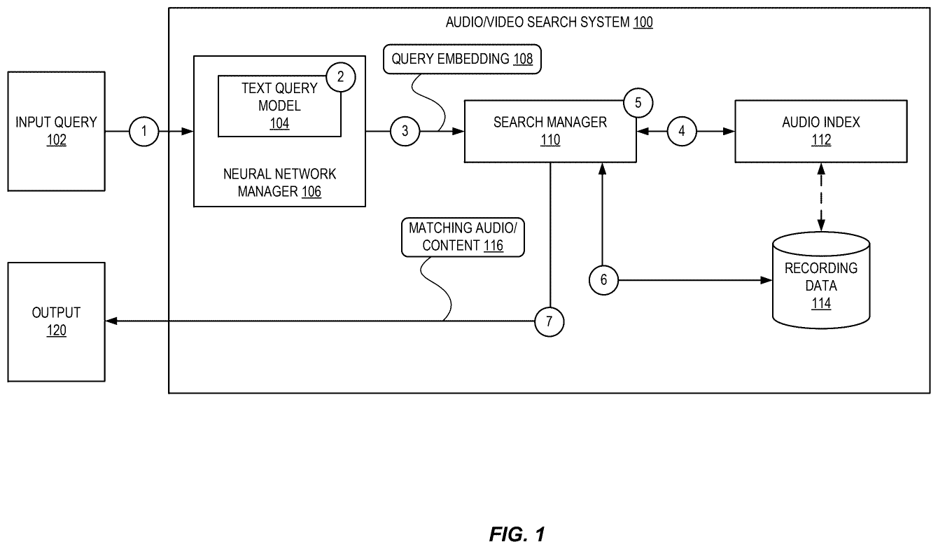

FIG. 1 illustrates a diagram of a process of searching recording data in accordance with one or more embodiments. As shown in FIG. 1, an audio/video search system 100 may be configured to process queries of audio content. The audio/video search system 100 may be implemented as, or executing on, a Network Video Recorder (NVR). The NVR may be a computing device, comprising one or more processing devices (central processing units, graphics processing units, accelerators, field programmable gate arrays, etc.), deployed to a customer site. In examples described herein, a customer site may refer to any location or locations where one or more NVRs and one or more audio capture devices (e.g., microphones) are deployed. The customer site may also be referred to as a surveillance location. In various embodiments, audio capture devices may be deployed as part of an audio/video capture device, such as a surveillance camera, or as standalone microphone. The audio capture device may include any device capable of recording audio data.

At numeral 1, the audio/video search system 100 receives an input query 102. The query may be received locally (e.g., via a user interface on the same device on which the audio/video search system is executing), via a local web interface (e.g., over a local area network or other local network, or via a remote web interface (e.g., a hosted search service in a cloud provider system, etc.). The user interface may include a terminal or dashboard. In some embodiments, the user interface may include a speech-to-text interface which transcribes the input query from a voice input. In some embodiments, the input query 102 may be a natural language text query. The input query 102 provides a textual description of an event of interest. For example, the query may describe a sound (e.g., gunshot, glass breaking, etc.), a description of the people speaking (e.g., by pitch or other identifiable vocal characteristics), or other event details. In some embodiments, the query may indicate a microphone location, microphone identifier, date, time, or other search parameters. For example, the query may be “find a glass breaking, heard by microphone 1 or microphone 2, during the day on May 28th.” In some embodiments, a user interface is provided allowing user to input text input using a web dashboard, connected terminal, generate text from speech-to-text translation, etc. Alternatively, the user can be presented with a predefined set of text queries.

The input query is received by a text query model 104. The text query model 104 may be a neural network which receives a text input and outputs one or more vector descriptors (e.g., embeddings) based on the text input. The text query model 104 may be an off-the-shelf model of various architectures. In some embodiments, the text query model 104 may be implemented as a transformer architecture. In various embodiments, the text query model may be trained in concert with a video indexing model (discussed further below) using text, image-text, and video-text pairs, or combinations thereof, such that related text and video data results in similar embeddings being generated by the respective models.

As shown in FIG. 1, the text query model 104 may be hosted by a neural network manager 106. The neural network manager 106 may be an execution environment provided by, or accessible to, the audio/video search system 100. The neural network manager 106 may include all of the data, libraries, etc. needed to execute the text query model 104. Additionally, in some embodiments, the neural network manager 106 may be associated with dedicated hardware and/or software resources for execution of the text query model 104. At numeral 2, the text query model processes the input query 102 to generate a query embedding 108. The query embedding 108 is then provided to search manager 110 at numeral 3.

Search manager 110 may act as an orchestrator for processing the query and returning a result. For example, at numeral 4, the search manager 110 can query an audio index 112 to identify similar audio embeddings to the query embedding. In some embodiments, the audio database may be a vector database which stores vector descriptor embeddings produced by an audio indexing model and associated metadata, such as, recording identifier, microphone identifier, time of day, date, etc. At numeral 5, the search manager 110 can identify similar vectors using L2, cosine similarity, or other similarity metric and number of additional metadata criteria, such as time range or microphone ID, etc. In some embodiments, the similar embeddings (e.g., those that meet a similarity threshold) may be returned to the search manager 110.

At numeral 6, the search manager 110 can use the similar embeddings to retrieve corresponding audio data (e.g., clips, snippets, etc.) from recording data 114. For example, the recording identifier metadata associated with each similar embedding may be used to look up the corresponding audio in recording data 114. In some embodiments, each audio snippet used to generate an embedding (e.g., a fixed length or variable length portion of audio) may be assigned a recording identifier which may be likewise assigned to the resulting embedding. Once a matching embedding has been identified, its recording ID may then be used to match the portion of the audio used to generate that embedding. In some embodiments, the recording ID may be one or more timestamp(s), time range, etc. corresponding to a particular audio file or audio files. The search manager can then return one or more of the matching audio contents to the user at numeral 7. The results are displayed back to the user as relevant audio/video clips capturing the event or otherwise indicate points in the audio/video stream when the relevant event is captured.

In some embodiments, the input query 102 and the matching audio output 120 may be received/returned via a user interface, such as a web dashboard. In some embodiments, the user interface displays relevant results to the user. For example, the matching content (e.g., audio and/or video data) may be ranked and presented to the user in order of ranking. The user can then select to listen to the matching audio, view the matching video, etc. In some embodiments, additional information and/or a summary of the search results may be presented, such as number of clips, or specifics relevant to the query.

The example described above corresponds to an installation with a single NVR. For example, the audio/video search system 100 executes on one NVR which has access to video data from all of the cameras at that installation. However, large-scale deployments of several hundreds of cameras or across multiple locations may require several edge devices (e.g., NVRs) to be installed. In such embodiments, the NVRs may execute in parallel, each processing data from a different subset of cameras. When a user provides input query 102, it may be sent to all NVRs. Each NVR may then process the query as described above and return a list of results (e.g., matching audio content). In some embodiments, each matching content also includes its associated similarity metric value. This allows for the matching content from each NVR to be merged into a single list, based on similarity, before being presented to the user.

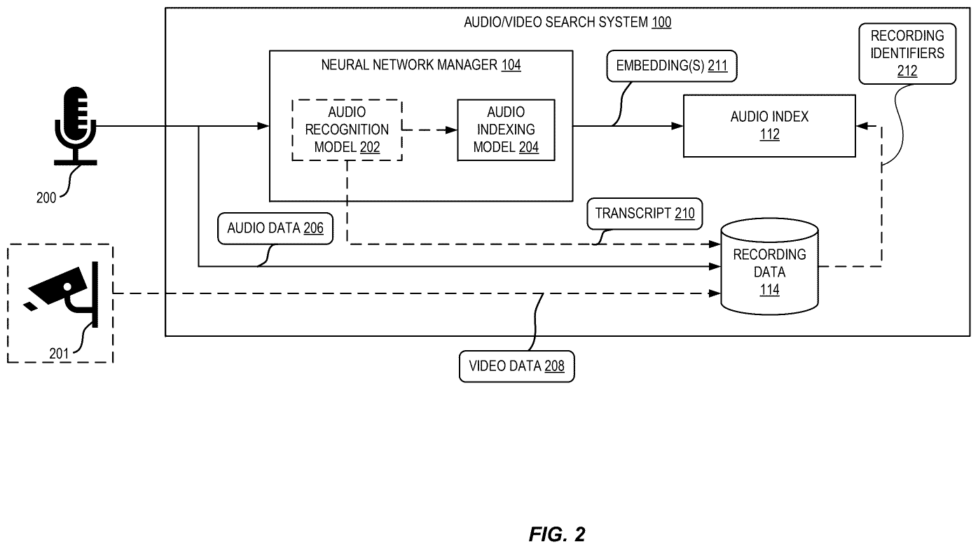

FIG. 2 illustrates a diagram of a process of indexing surveillance data for search in accordance with one or more embodiments. As described above, surveillance data captured at a customer site (e.g., surveillance location) may be recorded and queried using NLP or other search techniques. As discussed, the surveillance data may include audio surveillance data captured from one or more microphones, or other audio recording devices, located at the surveillance location. In some embodiments, the audio recording device may include a microphone deployed as part of a video surveillance device which is configured to capture both audio and video surveillance data.

As shown in FIG. 2, a customer site can include one or more audio recording devices 200. The audio recording devices 200 may include any capable of transmitting audio data recorded at the client site (e.g., streaming audio data over a network, such as the Internet, transmitting audio via radio transmissions, etc.). In some embodiments, the customer site may optionally include one or more surveillance cameras 201 (e.g., video recording devices which may be capable of also recording audio). The surveillance cameras 201 may include any networkable image or video capture devices, such as IP cameras. As used herein, networkable may refer to any device capable of wired or wireless communication with the audio/video search system 100.

The microphones 200 may be deployed to various locations around a customer site. Each camera may stream video data to the audio/video search system 100. When the audio data is received it is processed by one or more machine learning models. The one or more machine learning models may be configured to receive all or portions of the audio data and generate an embedding that represents that audio data. For example, in some embodiments, the audio data may be processed by an audio recognition model 202 and an audio indexing model 204. Alternatively, the audio data may be processed only by the audio indexing model 204. As discussed, the audio/video search system 100 may include a neural network manager 106 that provides an execution environment for one or more machine learning models. In some embodiments, multiple models may execute in the same neural network manager. Alternatively, each machine learning model may be associated with its own neural network manager.

In some embodiments, the audio recognition model 202 may include a neural network which receives the incoming audio as input and produces a text transcript of the spoken words as output. The audio recognition model may be implemented using various architectures, such as a transformer-based architecture, or provided by 3rd-party systems. In addition to spoken words, in some embodiments, the audio recognition model 202 may be trained to identify specific sounds using particular tokens. For example, it can, optionally, also use specific format of words, e.g., “[dog barking]” to describe the sound of a dog barking in the audio data. In some embodiments, the audio recognition model 202, or a separate audio processing model, may be configured to further analyze the audio data. For example, a sentiment analysis may be performed and used to augment the transcription of the audio data to include both text data and likely emotional content of the corresponding text data.

The audio indexing model 204 can be implemented as a neural network which accepts a snippet of text transcript as input and produces a vector embedding as output. In some embodiments, the embedding is a vector of numbers of particular fixed length, e.g., 512. In such embodiments, the audio indexing model 204 can be used to encode both the transcribed text obtained from the recorded audio, as well as user queries (e.g., the audio indexing model 204 and the text query model 104 may be implementations of the same model). The property of embeddings of similar texts in terms of context have similar embeddings as measured in e.g., cosine similarity. This allows for query embeddings and audio embeddings that are similar, to be identified using a similarity metric, such as cosine similarity. In some embodiments, the audio indexing model 204 can be implemented using one of various architectures, such as a transformer-based architecture, or provided by 3rd-party systems. In some embodiments, the audio indexing model 204 can be augmented to compute embeddings of both text and videos to support multi-modal search.

Alternatively, in some embodiments, the audio recorded by the one or more audio recording devices 200 may be passed directly to audio indexing model 204. For example, all or some of the audio data recorded by audio recording device(s) 200 may be provided to audio indexing model 204. In such instances, audio indexing model 204 may be a machine learning model that has been trained to generate an embedding that represents the audio data received by the model. The audio indexing model 204 may be trained to generate embeddings for audio data and corresponding text data to be “close” within the same embedding space. Such a multi-modal model may then be deployed both for indexing audio data using the audio embeddings and for searching for audio data that matches a text query by comparing the audio embeddings to an embedding generated for the text query.

In both examples discussed above, the resulting embedding(s) 211 generated by the audio indexing model 204 may then be stored in audio index 112. Audio index 112 may be a vector database storing vector descriptor embeddings produced by the audio indexing model 204. In some embodiments, this may include several million entries and associated metadata, such as, recording ID, microphone ID, time of day, date, etc. The use of a vector database allows for fast retrieval and similarity search for the query vector based on L2 or cosine vector distance and a number of additional metadata criteria, such as time range or microphone ID. In some embodiments, the audio index 112 also performs aggregation of the retrieved results to remove duplicates or perform additional processing or summarization.

In some embodiments, at the same time as the audio data is being indexed, the audio data 206 is also being stored to recording data 114. In some embodiments, the streaming audio data is stored directly into recording data 114 which may include a local or remote data store. Optionally, video data 208 may also be stored to recording data 114. In some embodiments, the transcript 210 of the audio data generated by the audio recognition model 202 may also be stored in recording data 114. The recording data 114 may be stored for a set amount of time before being overwritten by new surveillance data. In some embodiments, each snippet may be associated with a recording identifier 212. The recording identifier may be a time stamp or other arbitrary identifier value that uniquely identifies the corresponding snippet. These recording identifiers may be synchronized with the vector database, such that the audio index embeddings and the recording data share the same recording identifiers. This allows for retrieval of stored audio/video/transcripts based on timestamp, time range or video ID.

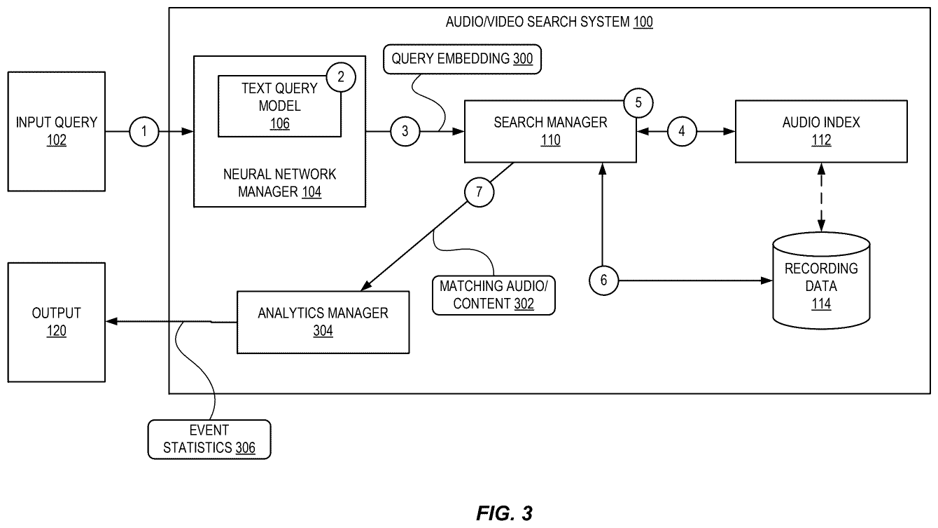

FIG. 3 illustrates a diagram of a process of providing analytics data corresponding to recording events in accordance with one or more embodiments. As discussed above, audio/video search system 100 can enable a user or other entity to search through surveillance data for a specific event. In particular, a user may describe an event and a matching event may be identified within surveillance audio data recorded at a customer site.

In the example of FIG. 3, processing may proceed as described from numerals 1-6 to identify audio content that matches the input query. For example, a text query is received and a query embedding 300 is generated corresponding to the query. This query embedding 300 is then used to identify similar embeddings in audio index 112. Based on these similar embeddings, audio content can be retrieved from recording data 114.

In some embodiments, rather than returning the matching audio content 302 to the user, the matching audio content 302 may be provided to analytics manager 304. Analytics manager 304 can determine statistics related to the occurrence of matching events over time. For example, as discussed, the audio content may include metadata indicating when it was recorded, where it was recorded, which audio capture device recorded the audio, etc. Analytics manager 304 can use this metadata to determine statistical information about the occurrence of the matching event(s). These event statistics 306 can then be returned as output 120. In some embodiments, the event statistics may be presented in addition to the matching audio content, rather than in place of. In some embodiments, the user may select whether to receive only the matching audio content, the matching audio content and the event statistics, or only the event statistics when submitting a query.

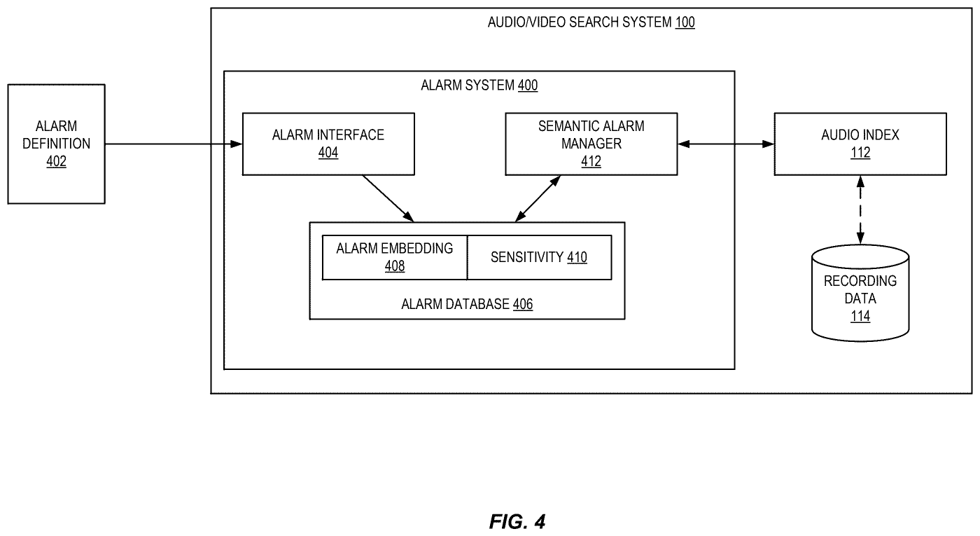

FIG. 4 illustrates a diagram of an alarm system in accordance with one or more embodiments. As shown in FIG. 4, the audio/video search system 100 can also include alarm system 400. As discussed above, alarm system 400 can provide real-time monitoring of the video data based on alarm definitions. Models, such as CLIP can compute ranking of videos based on the similarity between [0,1] to a user text query (0—most similar, 1—least similar). However, semantic alarms are binary events, either an alarm condition is present, or it is not. This presents challenges when attempting to determine whether a video actually shows an alarm condition. This can result in false positives and false negatives.

In some embodiments, an alarm definition 402 is received from a user or other entity. The alarm definition may be received via an alarm interface 404. For example, the alarm interface 404 may be a graphical user interface that walks the user through defining an alarm, the steps to be taken in response to the alarm, etc. The alarm interface can use the text query model, or similar model, to generate an alarm embedding 408 corresponding to the alarm definition. The alarm embedding 408 and a corresponding sensitivity 410 can be stored in alarm database 406.

Accordingly, when setting a semantic alarm, the user needs to provide an additional argument—sensitivity 410. Videos with a similarity value between the alarm embedding and the video embedding that is less than the threshold are then treated as positives and videos with similarity greater than threshold are treated as negatives.

To determine this threshold one of two techniques can be used. For arbitrary alarms that the user defines, a trial-and-error approach may be used. This enables the user to dial in the right sensitivity value such that precision and recall is acceptable and then optionally adjusting this sensitivity. For known alarms, e.g., “smoke detection”, the sensitivity parameter can be pre-computed.

Additionally, in some embodiments, the alarm system 400 can monitor video data in real-time and/or can review recorded video data to identify past alarm conditions. For example, as new audio data is recorded and added to the audio index 112 and recording data 114, the semantic alarm manager 412 can actively compare the alarm embeddings to the audio index 112. If a matching embedding is identified, based on the sensitivity value 410, then the alarm is triggered. In some embodiments, each alarm is associated with one or more actions to be performed. For example, notifications may be sent to specific employees, mitigation systems (e.g., sprinklers, etc.) may be activated at the customer site, emergency services may automatically be contacted, etc.

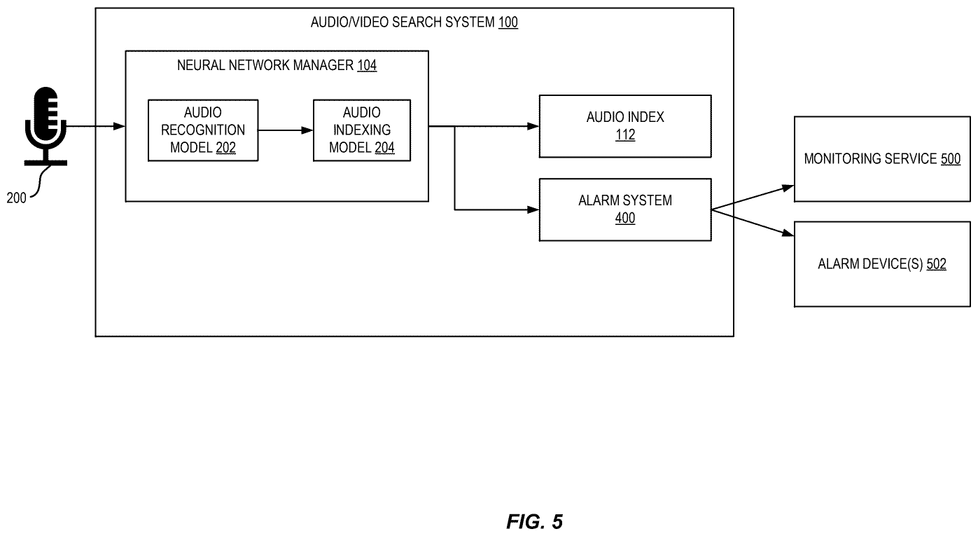

FIG. 5 illustrates a diagram of a process of generating alarms based on real-time recording monitoring in accordance with one or more embodiments. In some embodiments, as audio data is recorded it is processed by audio recognition model 202 and audio indexing model 204, as discussed above. This results in audio embedding(s) being generated for the recorded audio. The audio embeddings may be provided to audio index 112 and processing may continue as discussed above. Additionally, in some embodiments, the audio embeddings may be provided to alarm system 400. This allows the alarm system to process audio data in real-time to identify alarm events.

For example, when a new sound is detected, an audio embedding is generated. It can then be provided to alarm system 400 where it is compared to each alarm embedding 408, as discussed above. If the audio embedding is a match for an alarm embedding 408 (e.g., based on its corresponding sensitivity 410) then a corresponding alert is triggered. For example, the alarm system 400 may cause an alert to be sent to a monitoring service and or one or more alarm devices 502 (e.g., a warning message, siren, etc., may be played at the customer site, designated emergency personnel may be notified, etc.). In some embodiments, matching alarm conditions may be stored in an alarm data store. This enables historical analytics, such as, number of events that happened in the given period to be determined for the defined alarm conditions.

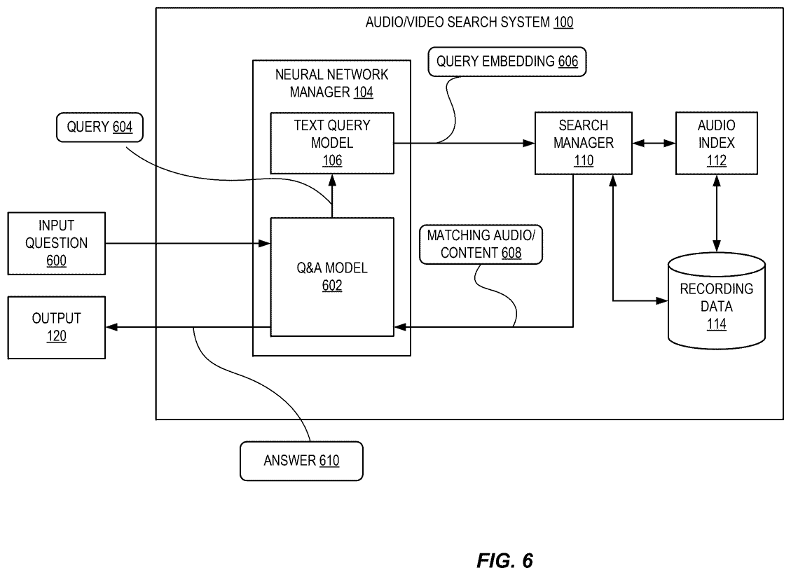

FIG. 6 illustrates a diagram of a question answering system for surveillance recordings in accordance with one or more embodiments. As shown in FIG. 6, audio/video search system 100 may also enable a question-answering system to be implemented for audio content. This may allow for topics discussed during meetings or queries customers asked about at a physical help desk, and details of captured conversations to be queried and/or summarized.

In some embodiments, an input question may be received by Q&A model 602. The Q&A model may be a transformer-based model trained to answer natural language questions about content. In the example of FIG. 6, the Q&A model may be trained to receive a text question and analyze audio content and/or transcripts of the audio content to process the user question. In some embodiments, the Q&A model 602 can generate an answer and return the answer to the user. However, where large amounts of data are to be processed, the Q&A model 602 can generate a query or queries to identify a subset of the audio data to be used to process the question.

For example, in some embodiments, a query 604 can be generated based on the user's question. As discussed above, a query embedding 606 can be generated for the query 604 and matching audio content can be retrieved by search manager 110. The matching audio content can be provided to the Q&A model 602 which can then generate an answer 610 to the user's question based on the question and the matching audio content.

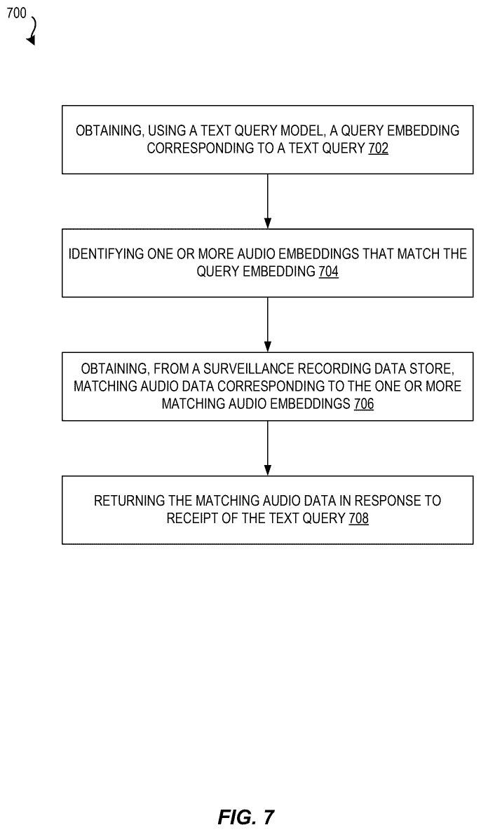

FIG. 7 illustrates a flowchart of a series of acts in a method of searching surveillance recording data in accordance with one or more embodiments. In one or more embodiments, the method 70000 is performed by or using the audio/video search system 100 (e.g., in a digital environment). The method 700 is intended to be illustrative of one or more methods in accordance with the present disclosure and is not intended to limit potential embodiments. Alternative embodiments can include additional, fewer, or different steps than those articulated in FIG. 7.

As illustrated in FIG. 7, the method 700 includes an act 702 of obtaining, using a

text query model, a query embedding corresponding to a text query. In various embodiments, the text query may be received through a user interface, such as a dashboard, web interface, app, etc.

As illustrated in FIG. 7, the method 700 includes an act 704 of identifying one or more audio embeddings that match the query embedding. In some embodiments, identifying one or more audio embeddings that match the query embedding, further includes comparing the query embedding to a plurality of audio embeddings using a similarity metric and determining the one or more audio embeddings based on the similarity metric and a similarity threshold.

As illustrated in FIG. 7, the method 700 includes an act 706 of obtaining, from a surveillance recording data store, matching audio data corresponding to the one or more matching audio embeddings. In some embodiments, the surveillance recording data store includes audio data, a transcript of the audio data, and recording identifiers corresponding to portions of the audio data. In some embodiments, the surveillance recording data store further includes video data corresponding to the audio data.

In some embodiments, obtaining, from a surveillance recording data store, matching audio data corresponding to the one or more matching audio embeddings, further includes identifying the matching audio data using a recording identifier associated with the one or more matching audio embeddings, wherein audio content stored in the surveillance recording data store are linked to audio embeddings in the vector database using recording identifiers.

As illustrated in FIG. 7, the method 700 includes an act 708 of returning the matching audio data in response to receipt of the text query. In some embodiments, the method may further include obtaining the matching audio data by an analytics manager and determining occurrence statistics associated with the matching audio data. The occurrence statistics associated with the matching audio data may then be returned.

In some embodiments, the method may further include obtaining real-time audio data and generating one or more real-time audio embeddings corresponding to the real-time audio data. An alarm system may process the one or more real-time audio embeddings to identify an alarm condition matching the one or more real-time audio embeddings and trigger an alert based on the alarm condition.

In some embodiments, the method may further include receiving, by a question answer model, a question associated with audio content stored on the surveillance recording data store. The question answer model can generate the text query, wherein the text query is to identify audio content relevant to the question. The question answer model can obtain the matching audio data corresponding to the text query and generate an answer to the question based on the matching audio data. The answer to the question can then be returned.

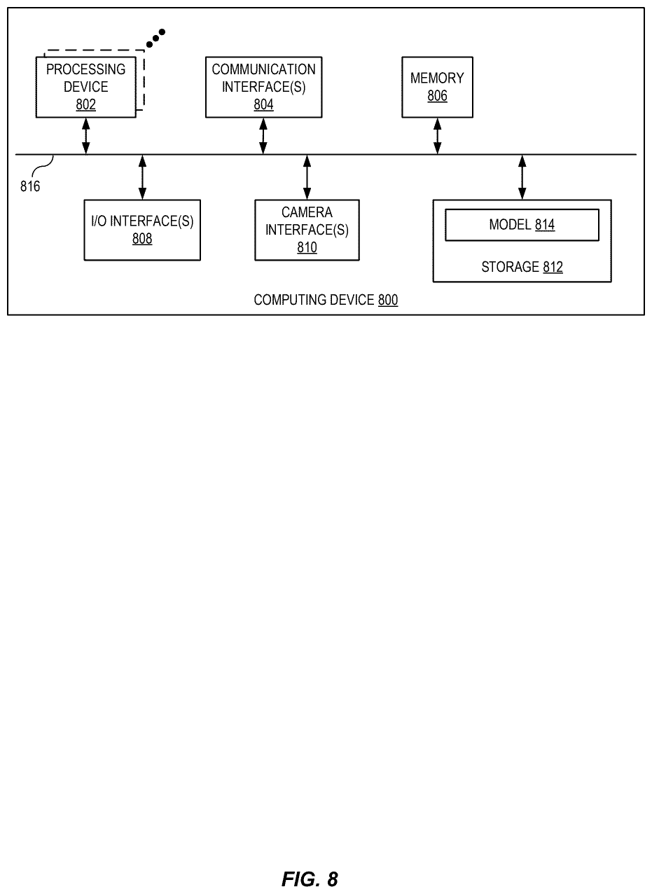

FIG. 8 illustrates a block diagram of an exemplary computing device 800 in accordance with one or more embodiments. The computing device 800 may represent an NVR implementing the audio/video search system 100 which is configured to perform one or more of the processes described above. As shown in FIG. 8, the computing device can comprise a processing device 802, communication interface(s) 804, memory 806, I/O interface(s) 808, video capture device (e.g., camera) interface(s) 810, and a storage device 812 including at least one model 814. In various embodiments, the computing device 800 can include more or fewer components than those shown in FIG. 8. The components of computing device 800 are coupled via a bus 816. The bus 816 may be a hardware bus, software bus, or combination thereof.

Processing device 802 includes hardware for executing instructions. The processing device 802 is configured to fetch, decode, and execute instructions. The processing device 802 may include one or more central processing units (CPUs), graphics processing units (GPUs), accelerators, field programmable gate arrays (FPGAs), systems on chip (SoC), or other processor(s) or combinations of processors.

A communication interface(s) 804 can include hardware and/or software communication interfaces that enable communication between computing device 900 and other computing devices or networks. Examples of communication interface(s) 804 include a network interface controller (NIC) or network adapter for communicating with an Ethernet or other wire-based network or a wireless NIC (WNIC) or wireless adapter for communicating with a wireless network, such as a WI-FI, etc.

Memory 806 stores data, metadata, programs, etc. for execution by the processing device. Memory 806 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 806 may be internal or distributed memory.

In some embodiments, the computing device 800 includes input or output (“I/O”) interfaces 808. The I/O interface(s) enable a user to interact with (e.g., provide information to and/or receive information from) the computing device 800. Examples of devices which may communicate via the I/O interfaces 808 include a mouse, keypad or a keyboard, a touch screen, camera, optical scanner, network interface, modem, or other I/O devices. The I/O interfaces 808 may also facilitate communication with devices for presenting output to a user. This may include a graphics engine, a display (e.g., a display screen), one or more output drivers (e.g., display drivers), one or more audio speakers, and one or more audio drivers. In some embodiments, graphical data corresponding to a graphical user interface is provided to a display for presentation to a user using the I/O interfaces.

In some embodiments, computing device 800 may include camera interfaces 810. Camera interfaces 810 may include high speed, high bandwidth, or otherwise specialized or dedicated interfaces to facilitate the transfer of large quantities of video data for processing by the computing device 800 in real time.

The computing device 800 also includes a storage device 812 for storing data or instructions, and one or more machine learning models 814, as described herein. As an example, and not by way of limitation, storage device 812 can comprise a non-transitory computer readable storage medium. The storage device 812 may include a hard disk drive (HDD), flash memory, a Universal Serial Bus (USB) drive or a combination of these or other storage devices.

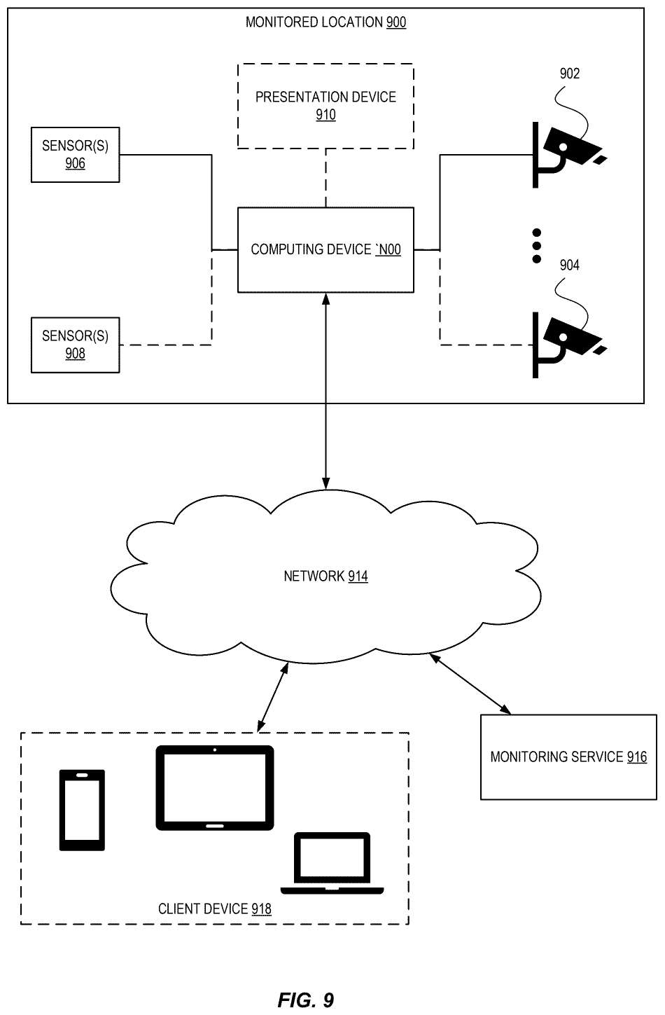

FIG. 9 illustrates a block diagram of an exemplary system in accordance with one or more embodiments. In the example of FIG. 9 a surveillance location 900 includes a computing device 800 on which the audio/video search system 90 can operate in accordance with one or more embodiments. The surveillance location 900 includes one or more video capture devices 902-904 in communication with the computing device 800 (e.g., via local wired or wireless networks). In some embodiments, the surveillance location may also include one or more sensors 906-908. These may include other devices which capture information about the surveillance location, such as audio sensors, LiDAR sensors, rangefinders, monocular cameras, non-visible spectra cameras, etc.

As discussed, the audio/video search system 90 executing on computing device 800 may include a query system 910 and a video indexing system 912. The query system 910 enables users to search live or stored video using natural language search techniques. The video indexing system 912 automatically generates embeddings for incoming video data and stores both the embedding data and video data for later search. A user may access the computing device 800 via a local presentation device 914 (e.g., monitor) and user input devices, or remotely via one or more client devices 916. When accessed remotely, the computing device 800 is accessed over one or more networks 918, such as the Internet. In some embodiments, a monitoring service 920 may be provided by a service provider or other entity to facilitate communication over the Internet between the client device 916 and the computing device 800. In various embodiments, the components shown in FIG. 9 may communicate using any communication platforms and technologies suitable for transporting data and/or communication signals, including any known communication technologies, devices, media, and protocols supportive of remote data communications.

As illustrated in FIG. 9, the environment may include client devices 916. The client devices 916 may comprise any computing device. For example, client devices 916 may comprise one or more personal computers, laptop computers, mobile devices, mobile phones, tablets, special purpose computers, TVs, or other computing devices. Although three client devices are shown in FIG. 9, it will be appreciated that client devices 916 may comprise any number of client devices (greater or smaller than shown).

The one or more networks 918 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 918 may be any suitable network over which the client devices 916 may access computing device 800, monitoring service 920, or vice versa.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

1. A method, comprising:
receiving, by a text query model, a text query including descriptors for an event of interest;
generating, using the text query model, a query embedding corresponding to the text query, wherein the text query model is a transformer model trained to encode the descriptors in the text query into the query embedding, and wherein the query embedding is a vector representation of the descriptors in the text query;
comparing the query embedding with a plurality of audio embeddings from a vector database using a similarity metric, wherein the plurality of audio embeddings are generated from transcriptions of audio data;
identifying one or more audio embeddings from the plurality of audio embeddings that match the query embedding;
obtaining, from a surveillance recording data store, matching audio data corresponding to the one or more matching audio embeddings; and
returning the matching audio data in response to receipt of the text query.

2. The method of claim 1, wherein the surveillance recording data store includes the audio data, the transcriptions of the audio data, and recording identifiers corresponding to portions of the audio data.

3. The method of claim 2, wherein the surveillance recording data store further includes video data corresponding to the audio data.

4. The method of claim 2, wherein obtaining, from a surveillance recording data store, matching audio data corresponding to the one or more matching audio embeddings, further comprises:
identifying the matching audio data using a recording identifier associated with the one or more matching audio embeddings, wherein audio content stored in the surveillance recording data store are linked to audio embeddings in a vector database using recording identifiers.

5. The method of claim 1, wherein identifying one or more audio embeddings from the plurality of audio embeddings that match the query embedding, further comprises:
determining the one or more audio embeddings based on the similarity metric and a similarity threshold.

6. The method of claim 1, further comprising:
obtaining the matching audio data by an analytics manager;
determining occurrence statistics associated with the matching audio data; and
returning the occurrence statistics associated with the matching audio data.

7. The method of claim 1, further comprising:
obtaining real-time audio data;
generating one or more real-time audio embeddings corresponding to the real-time audio data; and
processing the one or more real-time audio embeddings by an alarm system, wherein the alarm system is configured to:
identify an alarm condition matching the one or more real-time audio embeddings; and
trigger an alert based on the alarm condition.

8. The method of claim 1, further comprising:
receiving, by a question answer model, a question associated with audio content stored on the surveillance recording data store;
generating, by the question answer model, the text query, wherein the text query is to identify audio content relevant to the question;
obtaining, by the question answer model, the matching audio data corresponding to the text query;
generating, by the question answer model, an answer to the question based on the matching audio data; and
returning the answer to the question.

9. A non-transitory computer-readable storage medium including instructions which, when executed by a processor, cause the processor to perform operations comprising:
receiving, by a text query model, a text query including descriptors for an event of interest;
generating, using the text query model, a query embedding corresponding to the text query, wherein the text query model is a transformer model trained to encode the descriptors in the text query into the query embedding, and wherein the query embedding is a vector representation of the descriptors in the text query;
comparing the query embedding with a plurality of audio embeddings from a vector database using a similarity metric, wherein the plurality of audio embeddings are generated from transcriptions of audio data;
identifying one or more audio embeddings from the plurality of audio embeddings that match the query embedding;
obtaining, from a surveillance recording data store, matching audio data corresponding to the one or more matching audio embeddings; and
returning the matching audio data in response to receipt of the text query.

10. The non-transitory computer-readable storage medium of claim 9, wherein the surveillance recording data store includes the audio data, the transcriptions of the audio data, and recording identifiers corresponding to portions of the audio data.

11. The non-transitory computer-readable storage medium of claim 10, wherein the surveillance recording data store further includes video data corresponding to the audio data.

12. The non-transitory computer-readable storage medium of claim 10, wherein the operation of obtaining, from a surveillance recording data store, matching audio data corresponding to the one or more matching audio embeddings, further comprises:
identifying the matching audio data using a recording identifier associated with the one or more matching audio embeddings, wherein audio content stored in the surveillance recording data store are linked to audio embeddings in a vector database using recording identifiers.

13. The non-transitory computer-readable storage medium of claim 9, wherein the operation of identifying one or more audio embeddings that match the query embedding, further comprises:
determining the one or more audio embeddings based on the similarity metric and a similarity threshold.

14. The non-transitory computer-readable storage medium of claim 9, wherein the operations further comprise:
obtaining the matching audio data by an analytics manager;
determining occurrence statistics associated with the matching audio data; and
returning the occurrence statistics associated with the matching audio data.

15. The non-transitory computer-readable storage medium of claim 9, wherein the operations further comprise:
obtaining real-time audio data;
generating one or more real-time audio embeddings corresponding to the real-time audio data; and
processing the one or more real-time audio embeddings by an alarm system, wherein the alarm system is configured to:
identify an alarm condition matching the one or more real-time audio embeddings; and
trigger an alert based on the alarm condition.

16. The non-transitory computer-readable storage medium of claim 9, wherein the operations further comprise:
receiving, by a question answer model, a question associated with audio content stored on the surveillance recording data store;
generating, by the question answer model, the text query, wherein the text query is to identify audio content relevant to the question;
obtaining, by the question answer model, the matching audio data corresponding to the text query;
generating, by the question answer model, an answer to the question based on the matching audio data; and
returning the answer to the question.

17. A system, comprising:
one or more audio capture devices positioned at a user location; and
a natural language monitoring device coupled to the one or more audio capture devices at the user location, wherein the natural language monitoring device includes at least one processor which performs operations comprising:
receiving, by a text query model, a text query including descriptors for an event of interest;
generating, using the text query model, a query embedding corresponding to the text query, wherein the text query model is a transformer model trained to encode the descriptors in the text query into the query embedding, and wherein the query embedding is a vector representation of the descriptors in the text query;
comparing the query embedding with a plurality of audio embeddings from a vector database using a similarity metric, wherein the plurality of audio embeddings are generated from transcriptions of audio data;
identifying one or more audio embeddings from the plurality of audio embeddings that match the query embedding;
obtaining, from a surveillance recording data store, matching audio data corresponding to the one or more matching audio embeddings; and
returning the matching audio data in response to receipt of the text query.

18. The system of claim 17, wherein the operations further comprise:
obtaining the matching audio data by an analytics manager;
determining occurrence statistics associated with the matching audio data; and
returning the occurrence statistics associated with the matching audio data.

19. The system of claim 17, wherein the operations further comprise:
obtaining real-time audio data;
generating one or more real-time audio embeddings corresponding to the real-time audio data; and
processing the one or more real-time audio embeddings by an alarm system, wherein the alarm system is configured to:
identify an alarm condition matching the one or more real-time audio embeddings; and
trigger an alert based on the alarm condition.

20. The system of claim 17, wherein the operations further comprise:
receiving, by a question answer model, a question associated with audio content stored on the surveillance recording data store;
generating, by the question answer model, the text query, wherein the text query is to identify audio content relevant to the question;
obtaining, by the question answer model, the matching audio data corresponding to the text query;
generating, by the question answer model, an answer to the question based on the matching audio data; and
returning the answer to the question.
